(19) United States
(12) Patent Application Publication
(10) Pub. No.: US 2023/0405765 A1
(43) Pub. Date: Dec. 21, 2023

(54) DUAL-CURE RESIN FOR PREPARING CHEMICAL MECHANICAL POLISHING PADS

(71) Applicant: CMC Materials LLC, Aurora, IL (US)

(72) Inventor: Chen-Chih TSAI, Naperville, IL (US)

(21) Appl. No.: 18/210,422

(22) Filed: Jun. 15, 2023

Related U.S. Application Data
(60) Provisional application No. 63/352,252, filed on Jun. 15, 2022.

(51) Int. Cl. B24D 3/32; B24D 18/00; C08G 18/10; C08G 18/81; C08G 18/04

(52) U.S. Cl. CPC B24D 3/32; B24D 18/0072; C08G 18/10; C08G 18/8175; C08G 18/04

(57) ABSTRACT

The invention provides a composition for preparing a chemical-mechanical polishing pad via photopolymerization and heating, the composition comprising a first component comprising: one or more acrylate-blocked isocyanates, one or more acrylate monomers and at least one photoinitiator. The composition further comprising a second component comprising one or more amine curatives. The invention also provides a method of forming a chemical-mechanical polishing pad comprising preparing a composition comprising: a first component comprising one or more acrylate-blocked isocyanates, one or more acrylate monomers and at least one photoinitiator. The composition further comprising a second component comprising one or more amine curatives. The method further comprising exposing at least a layer of the composition to ultraviolet light, thereby initiating a polymerization reaction and thus forming at least a layer of solidified pad material; and heating the layer.

### TECHNICAL FIELD

This disclosure generally relates to chemical mechanical polishing, and more specifically to a dual-cure resin for preparing chemical mechanical polishing pads.

### BRIEF DESCRIPTION OF FIGURES

To assist in understanding the present disclosure, reference is now made to the following description taken in conjunction with the accompanying drawings, in which:

FIG. 1 is a block diagram illustrating a composition of an improved dual-cure resin for preparing CMP pads, according to an illustrative embodiment of this disclosure;

FIG. 2 is a flowchart of an example process for preparing the composition of FIG. 1 and using the composition to prepare CMP pads;

FIG. 3 is a plot of relative removal rates achieved by the different sample CMP pads summarized in TABLE 1;

FIG. 4 is a plot of relative removal rate as a function of amine curative stoichiometry for the different sample CMP pads summarized in TABLE 1

FIGS. 5A and 5B are plots demonstrating the planarization efficiency (PE) of different-sized features achieved by the different sample CMP pads summarized in TABLE 1;

FIGS. 6A-H are scanning electron microscopy (SEM) images of the surfaces of the different sample CMP pads summarized in TABLE 1;

FIG. 7 is a plot of tensile stress-strain curves of the different sample CMP pads summarized in TABLE 1; and

FIG. 8 is a plot of groove-depth (GD) loss displayed by the different sample CMP pads summarized in TABLE 1.

### DETAILED DESCRIPTION

It should be understood at the outset that, although example implementations of embodiments of the disclosure are illustrated below, the present disclosure may be implemented using any number of techniques, whether currently known or not. The present disclosure should in no way be limited to the example implementations, drawings, and techniques illustrated below. Additionally, the drawings are not necessarily drawn to scale.

An integrated circuit is typically formed on a substrate by the sequential deposition of conductive, semi-conductive, and/or insulative layers on a silicon wafer. A variety of fabrication processes require planarization of at least one of these layers on the substrate. For example, for certain applications (e.g., polishing of a metal layer to form vias, plugs, and lines in the trenches of a patterned layer), an overlying layer is planarized until the top surface of a patterned layer is exposed. In other applications (e.g., planarization of a dielectric layer for photolithography), an overlying layer is polished until a desired thickness remains over the underlying layer. Chemical-mechanical planarization, also known as chemical-mechanical polishing (both referred to as “CMP”), is one accepted method of planarization. This planarization method typically requires that the substrate be mounted on a carrier head. The exposed surface of the substrate is typically placed against a polishing pad on a rotating platen. The carrier head provides a controllable load (e.g., a downward force) on the substrate to push it against the rotating polishing pad. A polishing liquid, such as slurry with abrasive particles, can also be disposed on the surface of the polishing pad during polishing.

One objective of a CMP process is to achieve a high polishing uniformity. If different areas on the substrate are polished at different rates, then it is possible for some areas of the substrate to have too much material removed (“overpolishing”) or too little material removed (“underpolishing”). Conventional polishing pads, including standard pads and fixed-abrasive pads, can suffer from these problems. A standard pad may have a polyurethane polishing layer with a roughened surface and may also include a compressible backing layer. A fixed abrasive pad has abrasive particles held in a containment media and is typically supported on an incompressible backing layer.

These conventional polishing pads are typically prepared by molding, casting or sintering polyurethane materials. Molded polishing pads must be prepared one at a time (e.g., by injection molding). For casting polishing pads, a liquid precursor is cast and cured into a “cake,” which is subsequently sliced into individual pad sections. These pad sections must then be machined to a final thickness. Polishing pads prepared using conventional extrusion-based processes generally lack desirable properties for CMP (e.g., are too brittle for effective CMP).

CMP pads can also be formed using a vat-based additive manufacturing process, as described in U.S. patent application Ser. No. 16/868,965, filed May 7, 2020 and titled “CHEMICAL MECHANICAL PLANARIZATION PADS VIA VAT-BASED PRODUCTION,” wherein a plurality of thin layers of pad material are progressively formed. Each layer of the plurality of layers may be formed via UV-initiated reaction of a precursor material to form a thin layer of solidified pad material. The resulting pad is thus formed with a precisely controlled structure by projecting an appropriate pattern of light (e.g., UV irradiation) for forming each thin layer.

The use of an additive manufacturing process provides for various benefits and advantages. For example, one advantage of using an additive manufacturing process is the ability to generate a CMP pad comprising a continuous single-layer body, in contrast to the multi-layered body formed by extrusion-based CMP processes (which require a top-sheet adhered to a sub-pad via adhesives). Additionally, additive manufacturing processes can allow polishing pads to be formed with more tightly controlled physical and chemical properties than is possible using other conventional processes. For example, the process allows CMP pads to be prepared with unique groove and channel structures depending on the UV light image projected on the surface. The patterns on the layers can be applied by a computer aided design (CAD) program that controls the projected UV image pattern. The process also facilitates increased manufacturing throughput than is possible using other methods, including extrusion-based printing processes (e.g., processes involving a mechanical printhead with nozzles that eject precursor material onto a surface as the printhead is moved). The additive manufacturing process also reduces machine operation costs, material costs and labor costs, while also reducing the likelihood of human error.

The present disclosure seeks to improve upon existing CMP processes by providing an improved dual-cure resin for preparing CMP pads. The dual-cure resin includes a first component, which includes one or more acrylate-blocked isocyanates, one or more acrylate monomers, and at least one photoinitiator, and a second component, which includes an amine curative. The stoichiometry between the first component and second component is controlled to provide improved wear rate of resulting CMP pads and prevent or reduce smearing or loss of surface features during CMP processes. For example, a ratio of the first component to the second component may be in a range from about 1:0.6 (corresponding to a stoichiometry of 0.6 for the second component) to 1:0.8 (corresponding to a stoichiometry of 0.8 for the second component). Through this controlled stoichiometry, the CMP pads prepared using the dual-cure resin of this disclosure retain a desirable porous structure during use without smearing and becoming less porous, thereby improving CMP pad performance and usable lifetime.

The new dual-cure material of this disclosure can be used to prepare CMP pads with improved wear rates, while maintaining high removal rates. The improved dual-cure resin of this disclosure facilitates the efficient preparation of CMP pads using additive manufacturing processes, such as vat-based processes, extrusion-based processes, and the like. In certain embodiments, the resulting CMP pads display significantly lower wear rates than those of CMP pads prepared using conventional materials used for additive manufacturing. CMP pads of this disclosure have improved chemical and mechanical properties compared to those of previous additive-manufactured CMP pads and display beneficial performance properties, such as improved retention of porous surface structure, improved removal rates, and decreased wear rates. The CMP pads can also be prepared more efficiently and reliably than previous CMP pads.

It is also an object of this disclosure to provide a process for the preparation of CMP pads using a dual-cure resin that includes a first component with one or more acrylate-blocked isocyanates, one or more acrylate monomers, and at least one photoinitiator, and a second component with an amine curative. The stoichiometry of the second component relative to the first component may be in a range from 0.6 to 0.8.

### Example Composition

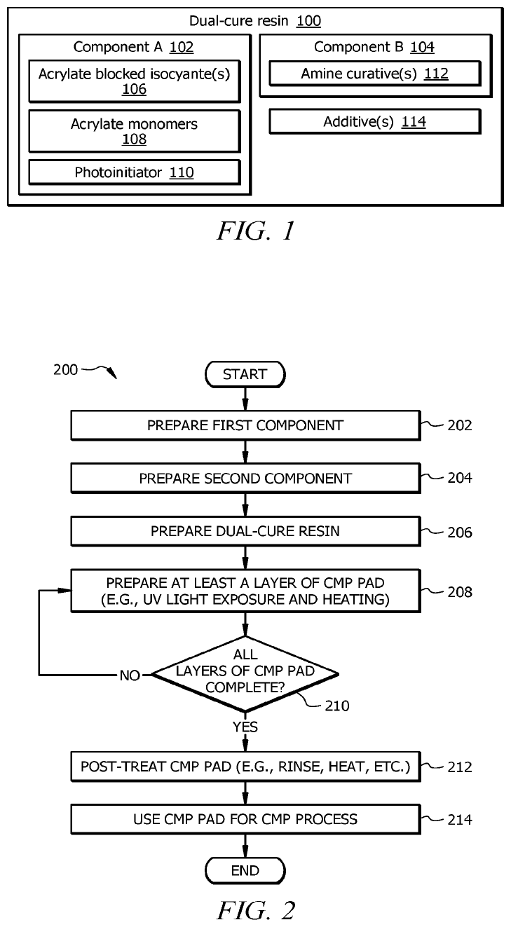

FIG. 1 illustrates an example composition of a dual-cure resin 100 for making a CMP pad. The dual-cure resin 100 includes a first component 102 (Component A) and a second component 104 (Component B). The first component 102 includes one or more acrylate blocked isocyanates 106, one or more acrylate monomers 108, and at least one photoinitiator 110. The second component 104 includes one or more amine curatives 112. Further details and examples of subcomponents of the first component 102 and second component 104 are provided below. The dual-cure resin 100 may optionally include additives 114, described further below.

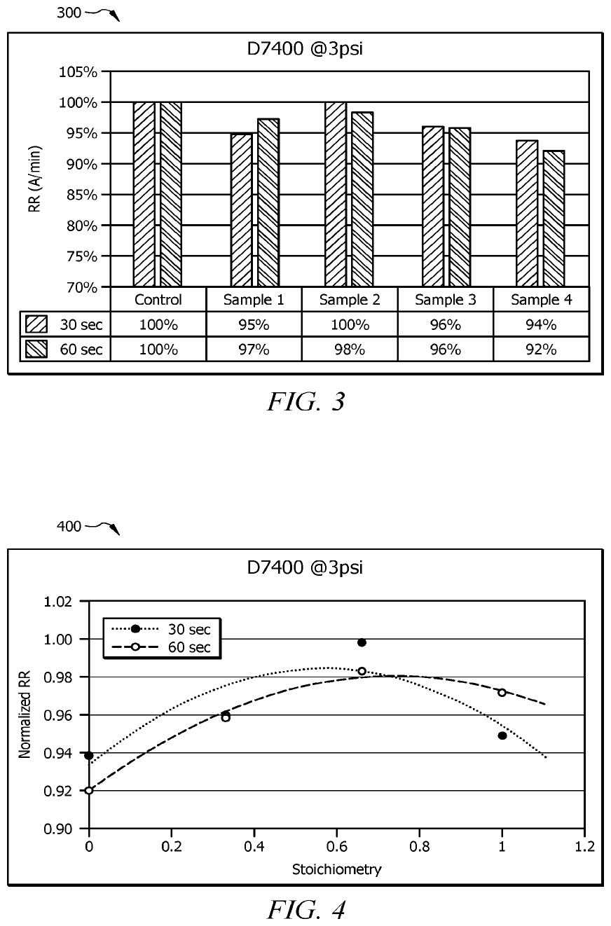

The dual-cure resin 100 may be solidified by exposing the dual-cure resin 100 to ultraviolet (UV) light and heating the dual-cure resin 100 to perform thermal curing. This disclosure recognizes that the mixture of acrylate and a urethane network resulting from this dual-curing approach may improve the resulting material's properties (e.g., tensile strength and elongation) for use as a CMP pad. This disclosure also recognizes that previous dual-cure type materials result in a material that has a smeared surface texture, in which micro-scale features that are generally beneficial for CMP process are lost after polishing. As a result, CMP pads prepared using previously available dual-cure formulations do not meet requirements of low wear rate and consistent removal rate. As described in greater detail below with respect to FIGS. 3-8, the new dual-cure resin 100 of this disclosure is able to achieve comparable removal rates (RR) and planarization efficiencies (PE) to those of previous CMP pads by adjusting surface texture through the stoichiometric control of the components included in the dual-cure resin 100. In addition, the pad wear rate (PWR) is similar to that of previous CMP pads, while other attempts to create resin-based CMP pads result in materials with very high wear rates that cannot be used in most applications.

The acrylate blocked isocyanates 106 (e.g., or acrylate urethane oligomers) can be selected from polyisocyanates or isocyanate-terminated urethane prepolymers. The free isocyanates are reacted with hydroxyl or amine-terminated acrylates to form the acrylate urethane oligomers. Specifically, acrylate blocked isocyanates comprise acrylate blocking agents such as 2-hydroxyethyl acrylate (HEA), 2-hydroxyethyl methacrylate (HEMA), 2-(tert-butylamino) ethyl methacrylate (TBEMA), and 3-(acryloyloxy)-2-hydroxypropyl methacrylate (AHPMA) with isocyanate-terminated urethane prepolymers, such as aromatic prepolymers (e.g., PET95A, PET75D, both commercially available from Coim USA, Inc., and 80DPLF, available commercially from Anderson Development Company), and aliphatic prepolymers (e.g., APC722, APC504, 51-95A, etc., also available commercially from Coim USA, Inc.).

The acrylate monomers 104 may act as reactive diluents to reduce the viscosity of the dual-cure resin 100. As used herein, the term acrylate can refer to methacrylates and acrylates. Acrylate monomers 104 may be mono-functional, di-functional, tri-functional, or multi-functional monomers. For example, the acrylate monomers 104 can include, but are not limited to, isobornyl methacrylate (IBMA), 2-carboxyethyl acrylate (CEA), 2-hydroxyethyl acrylate (HEA), ethylene glycol dimethacrylate (EGDMA), neopentyl glycol dimethacrylate (NGDMA), 3-(acryloyloxy)-2-hydroxypropyl methacrylate (AHPMA), trimethylolpropane triacrylate (TMPTA), and the like.

The photoinitiator 106 is used to initiate the polymerization reaction in regions exposed to light (e.g., UV irradiation). The photoinitiator can be activated at 365 nm, 405 nm, or another appropriate wavelength. For example, diphenylphosphine oxide (TPO) can be used as the photoinitiator, which may be irradiated by 365 nm light.

The amine curative(s) 112 included in the second component 104 react with isocyanates that are deblocked after exposure to UV light at increased temperature to form a solidified material. The amine curatives 112 may be primary, secondary, or tertiary amines. The amine curatives 112 may be aliphatic amines, aromatic amines, or amines with other modifications. Example amine curatives 112 include, but are not limited to, 4,4′-methylenebis(2-methylcyclohexylamine), poly(propylene glycol)bis(2-aminopropyl ether), 5-amino-1,3,3-trimethylcyclo-hexanemethylamine, trimethylolpropane tris[poly(propylene glycol), an amine-terminated ether, and the like. The stoichiometry of the second component 104 relative to the first component 102 is a molar ratio of the amount of second component 104 of the dual-cure resin 100 relative to the amount of the first component 102 of the dual-cure resin 100. For example, a stoichiometry of one corresponds to one mole of the second component 104 being included in the dual-cure resin 100 for each mole of the first component 102. This disclosure recognizes that the properties of CMP pads prepared from the dual-cure resin 100 may be improved at stoichiometry values between 0.6 and 0.8, as described with respect to the examples of FIGS. 3-8 below. As such, in certain embodiments, the stoichiometry of the amount of the second component 104 relative to the first component 102 in the dual-cure resin 100 is in a range from 0.6 to 0.8. This controlled stoichiometry (or relative amine curative amount) facilitates the preparation of CMP pads with improved surface textures that both improve CMP performance and increase pad lifetime (e.g., lower pad wear rate).

The additive(s) 114 may be added to the dual-cure resin 100 and may include stabilizers, plasticizers, porogen fillers, and/or pigments (e.g., carbon black or the like). Porogens are particles (e.g., microspheres) which expand in volume when heated. Porogens may cause the formation of pores in the CMP pad, which may further improve its performance.

### Example Method of Preparing CMP Pads

FIG. 2 illustrates an example process 200 for preparing a CMP pad using the dual-cure resin 100 of FIG. 1. In this example, a number of thin layers of pad material may be progressively formed using a vat-based additive manufacturing process or another additive manufacturing process. Each layer may be formed via UV-initiated reaction of the dual-cure resin 100 followed by a thermal treatment to form a thin layer of solidified pad material. The resulting pad is thus formed with a precisely controlled structure by projecting an appropriate pattern of light (e.g., UV irradiation) for forming each thin layer. Using process 200, CMP pads can be formed with more tightly controlled physical and chemical properties than is possible using conventional processes. For example, using process 200, CMP pads can be prepared with unique groove and channel structures as well as improved chemical and mechanical properties. Process 200 also facilitates increased manufacturing throughput than is possible using conventional methods.

As shown in FIG. 2, at step 202, the first component 102 is prepared. The first component 102 may be prepared by combining the one or more acrylate blocked isocyanates 106, one or more acrylate monomers 108, and at least one photoinitiator 110. As described above in conjunction with FIG. 1, the acrylate blocked isocyanate 106 may be selected from polyisocyanates or isocyanate-terminated urethane prepolymers. The acrylate monomers 108 may be mono-functional, di-functional, tri-functional, or multi-functional monomers. For example, the acrylate monomers can include IBMA, CEA, HEA, EGDMA, NGDMA, AHPMA, TMPTA, or the like. The photoinitiator 110 is a component that initiates a polymerization reaction in regions exposed to light (e.g., at 365 nm, 405 nm, or another appropriate wavelength).

At step 204, the second component 104 is prepared. The second component includes at least one amine curative 112. Examples of amine curatives 112 are provided above with respect to FIG. 1.

At step 206, the dual-cure resin 100 is prepared by combining the first component 102 and the second component 104. The stoichiometry of the second component 104 relative to the first component 102 may be in a range from 0.6 to 0.8. In other words, the dual-cure resin 100 may include from 0.6 to 0.8 parts of the second component 104 for each part of the first component 102. In some embodiments, one or more additives 114 are added to the dual-cure resin 100.

At step 208, at least one layer of a CMP pad is prepared. For example, a layer of the dual-cure resin 100 may be exposed to an appropriate pattern of UV light and subsequently heated to create at least a layer of the CMP pad. In an example in which a vat-based additive manufacturing process is used, a build platform of the additive manufacturing apparatus may be adjusted to a desired height (e.g., of about 5, 10, 15, 20, 25, 50, 100 micrometers, or more when appropriate) relative to a surface of the vat containing at least a thin film of the dual-cure resin 100. A light source is then used to “write” the structure of the layer of the CMP pad. For example, UV light may pass through a window at the bottom of the vat that is substantially transparent to the UV light (i.e., sufficiently transparent to UV light such that the intensity of the UV light can initiate a photoinitiated reaction of the dual-cure resin 100). In general, the regions of the dual-cure resin 100 that are exposed to the UV light (i.e., based on a “write” pattern) under appropriate reaction conditions are radically polymerized. Photo-radical polymerization occurs after exposure to the UV light. Photo-radical polymerization may proceed continuously as the build platform is raised. The patterns of grooves and channels may be controlled by the pattern of the UV light projected on each layer of dual-cure resin 100 during step 208. These patterns can be controlled by a CAD program that is used to design the pattern of the projected UV light. Heating may be performed after each layer of the CMP pad is formed or after all or a portion of the layers are ‘written” with UV light (e.g., at step 212, described below).

At step 210, a determination (e.g., by a controller or processor of the additive manufacturing apparatus used to prepare the CMP pad) is made of whether all layers of the CMP pad are complete (e.g., whether a desired pad thickness has been achieved). If the desired number of layers or thickness is not reached, the process 200 returns to step 208 and adds additional layer(s) to the CMP pad. For the example of a vat-based process, the build platform may be moved upward again to the desired height of the next layer, which may be the same as or different than the height of the previous layer. As the build platform is moved upward, uncured dual-cure resin 100 flows beneath the cured layer. In some embodiments, the process pauses to allow an appropriate volume of the dual-cure resin 100 to flow (e.g., determined by the diameter of the CMP pad being manufactured and the viscosity of the dual-cure resin 100). Operations are then repeated to write and cure the additional layer of the CMP pad which may include the same or a different structure (e.g., of grooves and/or channels) than the previous layer. Step 208 is repeated until a desired thickness of the CMP pad is achieved. The thickness of each layer of the CMP pad may be less than 50% of the total thickness of the CMP pad. A thickness of each layer may be less than 1% of the total thickness of the CMP pad or the polishing layer of the CMP pad.

Once all layers of the CMP pad are complete at step 210, the process 200 proceeds to step 212. At step 212, post treatment steps may be performed to prepare the CMP pad for storage and/or use. For example, the CMP pad may be removed from its build platform and any chemical and/or physical post treatments may be performed. For example, the CMP pad may be rinsed with one or more solvents. As another example, a heat treatment may be performed to further harden the CMP pad. In some embodiments, the pad is not rinsed. In some cases, portions of the CMP pad may be backfilled with a second material, as appropriate for a given application. At step 214, the CMP pad is used for a CMP process.

### Experimental Examples

Formulations with different amine curative stoichiometries were prepared and their properties were determined as described below with respect to FIGS. 3-8. TABLE 1 summarizes the different samples tested. The samples were prepared with Component A (corresponding to the first component 102 of FIG. 1) that includes TBEMA-blocked APC504 and 51-95A oligomers (i.e., APC504 and 51-95A oligomers capped with TBEMA) as the acrylate blocked isocyanate, IBMA and EGDMA as the acrylate monomers, and TPO as the photoinitiator and Component B (corresponding to the second component 104 of FIG. 1) that includes 4,4′-methylenebis(2-methylcyclohexylamine) and poly(propylene glycol) bis(2-aminopropyl ether) as the amine curative. The relative amounts of Component A and Component B in the different samples is shown in TABLE 1.

TABLE 1
Component amounts in
example dual-cure resin samples.

| | Component | Component |
|---|---|---|
| Sample ID | A amount | B amount |
| Sample 1 | 1 | 1 |
| Sample 2 | 1 | 0.66 |
| Sample 3 | 1 | 0.33 |
| Sample 4 | 1 | 0 |

Removal rates for the different samples were determined by performing CMP experiments using ceria slurry (D7400) from CMC Materials. FIG. 3 shows a plot 300 of the removal rates (RR) achieved by the different samples and by a control CMP pad. Removal rates in FIG. 3 are presented as a percentage of the removal rate achieved by the control CMP pad. The control CMP pad is the E6088 CMP pad commercially available from CMC Materials. Samples 1-3 displayed a removal rate similar to that of the control CMP pad. Sample 2 had a removal rate that most closely matched the control CMP pad. Sample 4 (with a stoichiometry of zero) had the lowest removal rate.

FIG. 4 shows a plot 400 of relative removal amounts achieved by Samples 1-4 as a function of the stoichiometry of Component B (i.e., the values in the third column of TABLE 1 above). As shown in FIG. 4, a stoichiometry value of between 0.6 to 0.8 provides a removal rate most similar to that of the control CMP pad.

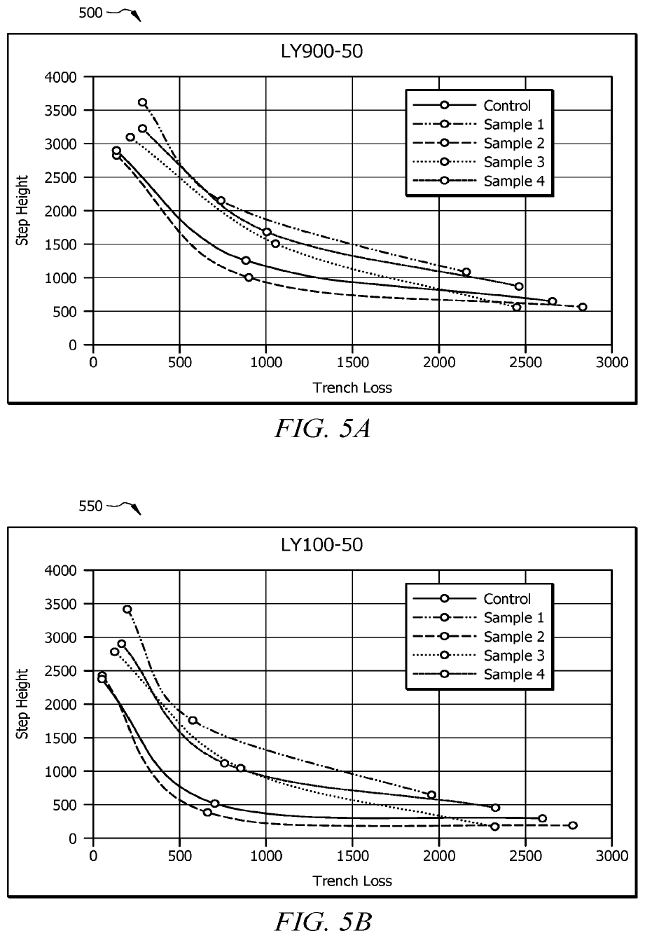

FIGS. 5A and 5B show plots 500 and 550 of the PE performance of CMP pads for planarizing 900 micrometer (μm)×900 μm features on an shallow trench isolation (STI) pattern and of 100 μm×100 μm features on an STI pattern, respectively. Sample 2 displayed the best PE performance among the tested samples and had a similar performance to that of the control CMP pad.

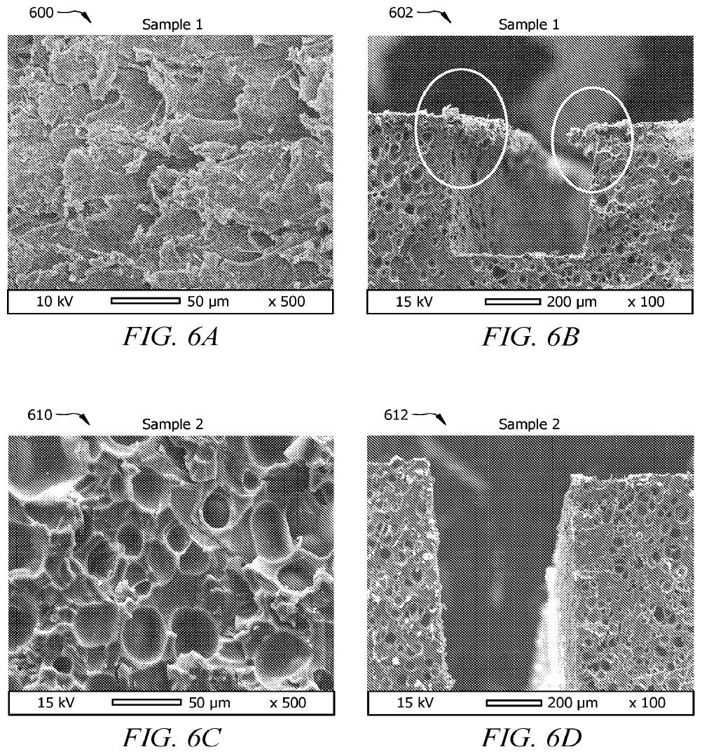

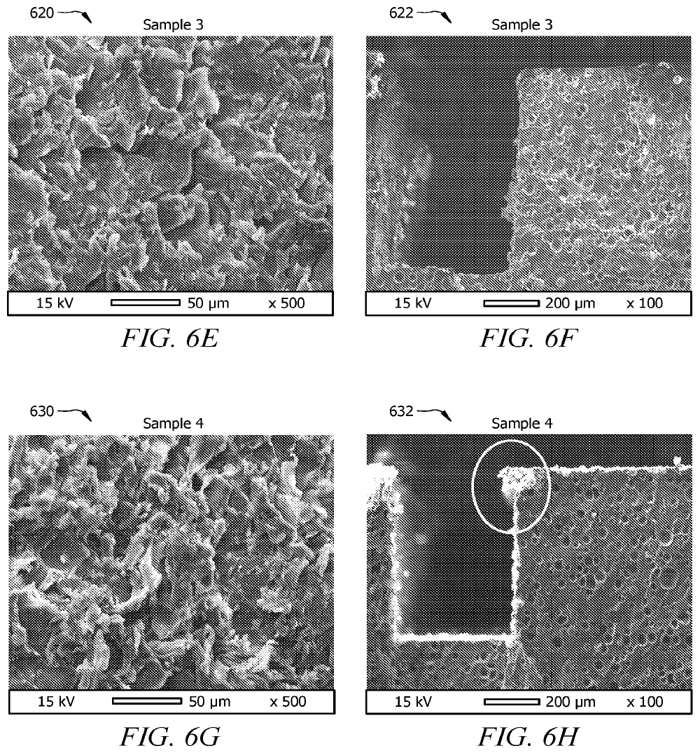

Scanning electron microscopy (SEM) images of the different samples were obtained to better understand the improved performance of Sample 2 compared to that of the other samples. FIGS. 6A-6H shown SEM images of the surfaces (top-down SEM images in FIGS. 6A, C, E, G and cross-sectional SEM images in FIGS. 6B, D, F, H) of the different samples of TABLE 1. FIGS. 6A and 6B show a top-down SEM image 600 and a cross-sectional SEM image 602 of Sample 1 after it was used for a CMP process. FIGS. 6C and 6D show a top-down SEM image 610 and a cross-sectional SEM image 612 of Sample 2 after it was used for a CMP process. FIGS. 6E and 6F show a top-down SEM image 620 and a cross-sectional SEM image 622 of Sample 3 after it was used for a CMP process. FIGS. 6G and 6H show a top-down SEM image 630 and a cross-sectional SEM image 632 of Sample 4 after it was used for a CMP process.

Sample 2 exhibited a texture with open pores and little or no smearing of the surface (see FIG. 6C). The other samples, however, show different degrees of surface smearing. The circled regions in FIG. 6B (Sample 1 with a stoichiometry value of one) and FIG. 6H (with a stoichiometry value of zero) show regions where the surface of the CMP pads smeared during the CMP process. The consistent and stable porous structure of Sample 2 may facilitate the improved PE performance demonstrated by the results shown in FIGS. 5A and 5B, and the stoichiometry (e.g., relative amount of amine curative used) played an unexpected role in achieving this porous surface texture.

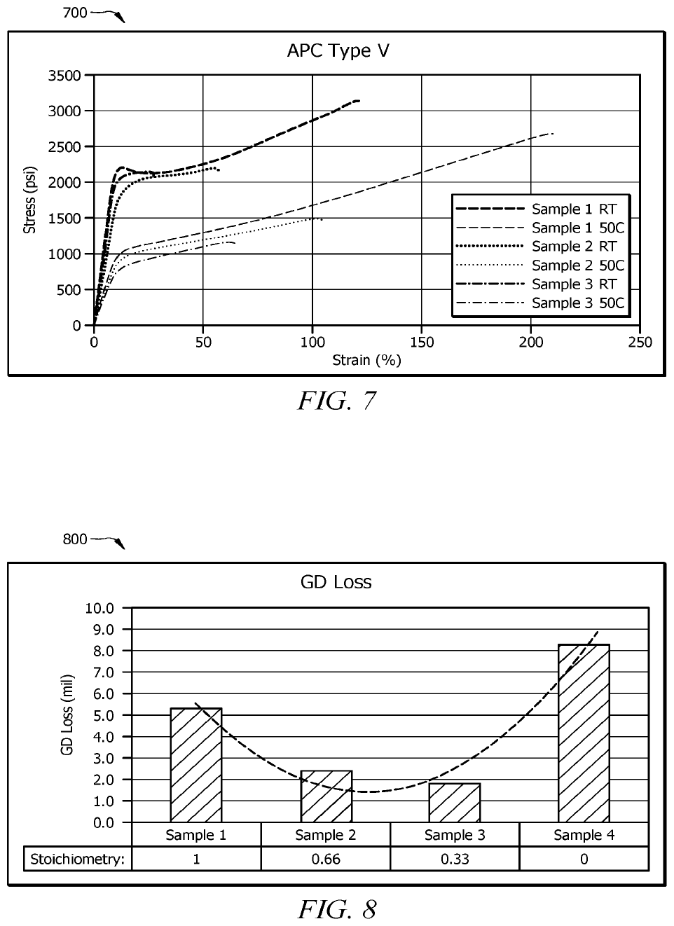

FIG. 7 shows a plot 700 of tensile stress versus strain for the different samples at different temperatures of room temperature (RT) and 50° C. As shown in FIG. 7, Sample 1 had the highest strength and elongation at break, which demonstrates that the dual-cure mechanism improves material properties. However, a yielding point occurred for Sample 1 at about 10% strain, which is not preferred for a CMP pad material because the material is more plastic-like rather than displaying a desirable thermosetting-type behavior. This behavior results in surface smearing during polishing. Conversely, Sample 2 has a beneficial balance between the thermoplastic-like and thermosetting-like properties that extends the tensile elongation, while providing a better surface for CMP processes. In other words, an improved acrylate and urethane polymer network was achieved by the stoichiometry of Sample 2.

FIG. 8 shows a plot 800 of groove depth (GD) loss of the different samples with different amine curative stoichiometries. GD loss was calculated as the difference between the GD before use for CMP processing and after their use in CMP processes. As shown in FIG. 8, Sample 4 (with a stoichiometry of zero) displayed the highest GD loss. Samples 2 and 3 had a significant reduction in GD loss. Unexpectedly, Sample 1 had an increased GD loss relative to those of Samples 2 and 3, further indicating the unexpected effectiveness of the dual-cure resin for CMP pad preparation with a stoichiometry in the range from 0.6 to 0.8.

Modifications, additions, or omissions may be made to the systems, apparatuses, and methods described herein. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended merely to better explain the disclosure and does not pose a limitation on the scope of claims.

We claim:

1. A composition for preparing a chemical-mechanical polishing pad via photopolymerization and heating, the composition comprising:
a first component comprising:
one or more acrylate-blocked isocyanates;
one or more acrylate monomers; and
at least one photoinitiator; and
a second component comprising one or more amine curatives.

2. The composition of claim 1, wherein a molar ratio of the first component and second component is in a range from about 1:0.6 to 1:0.8.

3. The composition of claim 1, further comprising one or more additives comprising one or more of: one or more stabilizers, one or more plasticizers, one or more porogen fillers, and one or more pigments.

4. The composition of claim 1, wherein the one or more acrylate-blocked isocyanates comprise an acrylate blocking agent and an isocyanate terminated urethane prepolymer.

5. The composition of claim 4, wherein the acrylate blocking agents are selected from 2-hydroxyethyl acrylate (HEA), 2-hydroxyethyl methacrylate (HEMA), 2-(tert-butylamino) ethyl methacrylate (TBEMA), and 3-(acryloyloxy)-2-hydroxypropyl methacrylate (AHPMA).

6. The composition of claim 4, wherein the isocyanate-terminated urethane prepolymers comprise one or both of one or more aromatic prepolymers and one or more aliphatic prepolymers.

7. The composition of claim 1, wherein the one or more acrylate-blocked isocyanates comprise a polyisocyanate.

8. The composition of claim 1, wherein the one or more acrylate monomers comprise one or more of isobornyl methacrylate (IBMA), 2-carboxyethyl acrylate (CEA), 2-hydroxyethyl acrylate (HEA), ethylene glycol dimethacrylate (EGDMA), neopentyl glycol dimethacrylate (NGDMA), 3-(acryloyloxy)-2-hydroxypropyl methacrylate (AHPMA), and trimethylolpropane triacrylate (TMPTA).

9. The composition of claim 1, wherein the at least one photoinitiator comprises diphenylphosphine oxide (TPO).

10. A chemical-mechanical polishing pad comprising polymerized material formed from polymerization of the composition of claim 1.

11. A method of forming a chemical-mechanical polishing pad comprising:
preparing a composition comprising:
a first component comprising:
one or more acrylate-blocked isocyanates;
one or more acrylate monomers; and
at least one photoinitiator; and
a second component comprising one or more amine curatives;
exposing at least a layer of the composition to ultraviolet light, thereby initiating a polymerization reaction and thus forming at least a layer of solidified pad material; and
heating the layer.

12. The method of claim 11, wherein a molar ratio of the first component and second component is in a range from about 1:0.6 to 1:0.8.

13. The method of claim 11, further comprising one or more additives comprising one or more of: one or more stabilizers, one or more plasticizers, one or more porogen fillers, and one or more pigments.

14. The method of claim 11, wherein the one or more acrylate-blocked isocyanates comprise an acrylate blocking agent and an isocyanate terminated urethane prepolymer.

15. The method of claim 14, wherein the acrylate blocking agents are selected from 2-hydroxyethyl acrylate (HEA), 2-hydroxyethyl methacrylate (HEMA), 2-(tert-butylamino) ethyl methacrylate (TBEMA), and 3-(acryloyloxy)-2-hydroxypropyl methacrylate (AHPMA).

16. The method of claim 14, wherein the isocyanate-terminated urethane prepolymers comprise one or both of one or more aromatic prepolymers and one or more aliphatic prepolymers.

17. The method of claim 11, wherein the one or more acrylate-blocked isocyanates comprise a polyisocyanate.

18. The method of claim 11, wherein the one or more acrylate monomers comprise one or more of isobornyl methacrylate (IBMA), 2-carboxyethyl acrylate (CEA), 2-hydroxyethyl acrylate (HEA), ethylene glycol dimethacrylate (EGDMA), neopentyl glycol dimethacrylate (NGDMA), 3-(acryloyloxy)-2-hydroxypropyl methacrylate (AHPMA), and trimethylolpropane triacrylate (TMPTA).

19. The method of claim 11, wherein the at least one photoinitiator comprises diphenylphosphine oxide (TPO).
